(19) United States
(12) Patent Application Publication
(10) Pub. No.: US 2014/0079285 A1
(43) Pub. Date: Mar. 20, 2014

(54) MOVEMENT PREDICTION DEVICE AND INPUT APPARATUS USING THE SAME

(71) Applicant: ALPS ELECTRIC CO., LTD., Tokyo (JP)

(72) Inventors: Tatsumaro YAMASHITA, Tokyo (JP); Takeshi SHIRASAKA, Tokyo (JP); Toshiyuki HOSHI, Tokyo (JP)

(73) Assignee: ALPS ELECTRIC CO., LTD., Tokyo (JP)

(21) Appl. No.: 13/950,913

(22) Filed: Jul. 25, 2013

(30) Foreign Application Priority Data
Sep. 19, 2012 (JP) 2012-205495

(51) Int. Cl. G06T 7/20

(52) U.S. Cl. CPC G06T 7/20
USPC 382/103

(57) ABSTRACT

A movement prediction device includes a CCD camera (image pickup device) for obtaining image information and a control unit for performing prediction of the movement of an operation body. In the control unit, a region regulation unit identifies a movement detection region on the basis of the image information, a computation unit computes, for example, a motion vector of a center of gravity of the operation body and tracks the movement locus of the operation body which has entered the movement detection region, and a movement prediction unit performs prediction of the movement of the operation body on the basis of the movement locus.

### CLAIM OF PRIORITY

This application contains subject matter related to and claims the benefit of Japanese Patent Application No. 2012-205495 filed on Sep. 19, 2012, the entire contents of which is incorporated herein by reference.

### BACKGROUND OF THE DISCLOSURE

1. Field of the Disclosure

The present disclosure relates to movement prediction devices that can predict movement of an operation body (for example, a hand) and to input apparatuses using the movement prediction devices for vehicles.

2. Description of the Related Art Japanese Unexamined Patent Application Publication No. 2005-274409 discloses a vehicle navigation apparatus. The vehicle navigation apparatus disclosed in Japanese Unexamined Patent Application Publication No. 2005-274409 includes a camera provided in a vehicle and image determination means that determines whether an operator is a driver or a passenger in a front passenger seat on the basis of images captured by the camera. When it is determined that the operator is a driver and the vehicle is moving, control is performed so as to disable the operation.

According to Japanese Unexamined Patent Application Publication No. 2005-274409, when an arm appears in a captured image, it is determined whether the operator is the driver or a passenger in the front passenger seat on the basis of, for example, the shape of the arm region.

According to Japanese Unexamined Patent Application Publication No. 2005-274409, it is determined whether or not a key input through an operation panel has been detected, and with this key input as a trigger, it is determined whether the operator is the driver or a passenger in the front passenger seat on the basis of, for example, the shape of an arm region included in a camera image.

In Japanese Unexamined Patent Application Publication No. 2005-274409, the operability of an operation panel is the same as that of the related art. In other words, when the operator is a passenger in the front passenger seat, input is performed through touching of the operation panel similarly to the related art and the aim is not to obtain operability which is better or quicker than that of the related art.

Further, in Japanese Unexamined Patent Application Publication No. 2005-274409, control for disabling the operation for the case where the operator is the driver is performed with a key input as a trigger, it is likely that determination as to whether or not the operation is to be disabled is delayed, thereby posing a problem in terms of safety.

Further, in Japanese Unexamined Patent Application Publication No. 2005-274409, since a key input is first required to disable an operation, an additional operation is necessary.

These and other drawbacks exits.

### SUMMARY OF THE DISCLOSURE

To solve the problems described above, the present disclosure provides a movement prediction device which, through prediction of the movement of an operation body, realizes improved operability compared with the related art and provides an input apparatus using the movement prediction device.

A movement prediction device in the present disclosure includes an image pickup device for obtaining image information and a control unit for performing movement prediction of movement of an operation body. The control unit tracks a movement locus of the operation body that has entered a movement detection region identified by the image information, and performs the movement prediction on the basis of the movement locus.

In this manner, the present disclosure includes a control unit that can identify a movement detection region on the basis of information obtained by an image pickup device and that can track a movement locus of an operation body moving in the movement detection region. In the present disclosure, movement prediction is possible on the basis of the movement locus of the operation body. Hence, movement prediction can be performed to predict what input operation will be performed on an input panel, for example, in a region in front of the operation panel through which an input operation is performed. As a result, operability different from that of the related art, quick operability, and comfortable operability can be obtained.

Further, when the movement prediction device is used in a vehicle, safety during driving can be increased to a level higher than that of the related art.

In the present disclosure, input operation control can be performed on the basis of prediction of the movement of the operation body. Hence, the input operation control is not performed with a key input as a trigger as disclosed in the invention of Japanese Unexamined Patent Application Publication No. 2005-274409. As a result, compared with the related art, an additional operation can be eliminated.

In the present disclosure, the control unit computes a position of a center of gravity of the operation body, and track a motion vector of the center of gravity as the movement locus of the operation body. With this configuration, the tracking of the movement locus of the operation body and the movement prediction based on the movement locus can be performed easily and smoothly.

In the present disclosure, the movement prediction device estimates a hand portion of the operation body whose image has been obtained in the movement detection region, and track a movement locus of the hand. Although the movement detection region includes not only the hand portion but also the arm portion, by trimming other portions except for the hand portion and looking at the movement locus of the hand, the movement locus can be easily computed, the computation load of the control unit can be reduced, and the movement prediction is facilitated.

In the present disclosure, the estimation of the hand is performed through a step of detecting an outline of the operation body, a step of obtaining sizes of portions of the outline and making a region including the portions with the sizes larger than or equal to a predetermined value be an effective region, and a step of detecting a region circumscribing the outline in the effective region and determining whether or not a vertical length of the region circumscribing the outline is smaller or equal to a threshold. When the vertical length of the circumscribing region is smaller than or equal to the threshold, a center of the effective region be defined as the center of gravity of the hand. Further, when the vertical length of the circumscribing region is larger than the threshold, the determination regarding the effective region be performed again in a state in which the vertical length of the circumscribing region is limited and an estimated region of the hand is defined. With this configuration, the estimation of the hand can be appropriately performed.

In the present disclosure the control unit tracks the movement locus of the operation body from a position through which the operation body entered the movement detection region. In other words, by determining which of the sides (boundaries) of the movement detection region the operation body passed through to enter the movement detection region, it becomes easy to identify the operator.

In the present disclosure, the movement detection region is divided into a plurality of sections and the control unit performs the movement prediction on the basis of a fact that the movement locus of the operation body has entered a predetermined section among the plurality of sections. In this manner, in the present disclosure, since the movement prediction is performed on the basis of the fact that an operation body has entered a predetermined section while the movement locus of the operation body is tracked, a load on the control unit for the movement prediction is reduced and the accuracy of the movement prediction is increased.

An input apparatus in the present disclosure includes the movement prediction device described above and an operation panel for which an input operation is performed by the operation body. The movement prediction device and the operation panel are provided in a vehicle. The image pickup device is arranged in such a manner that at least an image of a region in front of the operation panel is obtained. The control unit performs operation support for the operation panel on the basis of the movement prediction of the movement of the operation body.

In this manner, in the present disclosure, prediction of the movement of an operation body is performed at a position in front of an operation panel on which an operator performs an input operation, whereby comfortable operability and safety can be increased.

In the present disclosure, the control unit may be capable of identifying whether an operator for the operation panel is a driver or a passenger other than the driver on the basis of a position through which the operation body enters the movement detection region. In the present disclosure, by tracking the movement locus of an operator from a position through which the operation body enters the movement detection region, it can be easily and appropriately determined whether the operator is a driver or a passenger other than the driver.

### BRIEF DESCRIPTION OF THE DRAWINGS

FIG. 1 is a partial schematic diagram illustrating the inside of a vehicle provided with an input apparatus according to an exemplary embodiment;

FIG. 2 is a block diagram of the input apparatus according to an exemplary embodiment;

FIG. 3 is a schematic diagram illustrating an image captured by a CCD camera (image pickup device);

FIG. 4A is a schematic diagram illustrating a side view of the image pickup device, an operation panel, and the range of an image captured by the image pickup device according to an exemplary embodiment;

FIG. 4B is a schematic diagram illustrating a front view of the image pickup device, the operation panel, and the range of an image captured by the image pickup device according to an exemplary embodiment;

FIGS. 5A, 5B, 5C, and 5D are block diagrams illustrating steps of estimating a hand portion according to an exemplary embodiment;

FIG. 6A is a flowchart illustrating steps from reading of image information of the CCD camera (image pickup device) to performing of operation support for the operation panel according to an exemplary embodiment;

FIG. 6B is a flowchart illustrating a step of estimating particularly a hand portion according to an exemplary embodiment;

FIG. 7 is a schematic diagram illustrating the movement locus of the operation body (hand) of a driver in a movement detection region identified by the image information of the CCD camera according to an exemplary embodiment;

FIG. 8 is a schematic diagram illustrating the case in which an operation body has entered a first section closer to the operation panel when the movement locus of the operation body (hand) illustrated in FIG. 7 is tracked according to an exemplary embodiment;

FIG. 9 is a schematic diagram illustrating the case in which the operation body (hand) of a driver has directly entered the first section closer to the operation panel according to an exemplary embodiment;

FIG. 10 is a schematic diagram illustrating an input operation screen of the operation panel according to an exemplary embodiment;

FIG. 11A, which illustrates a form of operation support for the operation panel, is a schematic diagram illustrating a state in which an icon for which an input operation of an operation body is predicted on the basis of movement prediction is enlarged and displayed according to an exemplary embodiment;

FIG. 11B, which is a modification of FIG. 11A, is a schematic diagram illustrating a state in which an icon is enlarged and displayed, as a form different from that of FIG. 11A according to an exemplary embodiment;

FIG. 12, which illustrates a form of operation support for the operation panel, is a schematic diagram illustrating a state in which an icon for which an input operation of an operation body is predicted on the basis of movement prediction is lit according to an exemplary embodiment;

FIG. 13, which illustrates a form of operation support for the operation panel, is a schematic diagram illustrating a state in which an icon for which an input operation of an operation body is predicted on the basis of movement prediction is overlaid with a cursor according to an exemplary embodiment;

FIG. 14, which illustrates a form of operation support for the operation panel, is a schematic diagram illustrating a state in which icons other than an icon for which an input operation of an operation body is predicted on the basis of movement prediction are displayed in a grayed out state according to an exemplary embodiment;

FIG. 15, which illustrates a form of operation support for the operation panel, is a schematic diagram illustrating a state in which all the icons on the operation panel are grayed out according to an exemplary embodiment;

FIG. 16 is a schematic diagram for explaining the movement locus of an operation body (hand) of a passenger (operator) in a front passenger seat in a movement detection region identified by the image information of a CCD camera according to an exemplary embodiment;

FIG. 17 is a schematic diagram for explaining the movement locus of an operation body (hand) of a passenger (operator) in a back passenger seat in a movement detection region identified by the image information of a CCD camera according to an exemplary embodiment;

FIG. 18 is a schematic diagram illustrating the tracking of a movement locus, different from that in FIG. 8, of the operation body (hand) of a driver according to an exemplary embodiment;

FIG. 19 is a schematic diagram illustrating a state in which the operation bodies (hands) of both a driver and a passenger in a front passenger seat have entered a movement detection region according to an exemplary embodiment; and

FIG. 20 is a schematic diagram for explaining an algorithm for estimating the position of a finger according to an exemplary embodiment.

### DETAILED DESCRIPTION OF THE DISCLOSURE

The following description is intended to convey a thorough understanding of the embodiments described by providing a number of specific embodiments and details involving a movement input device. It should be appreciated, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending on specific design and other needs.

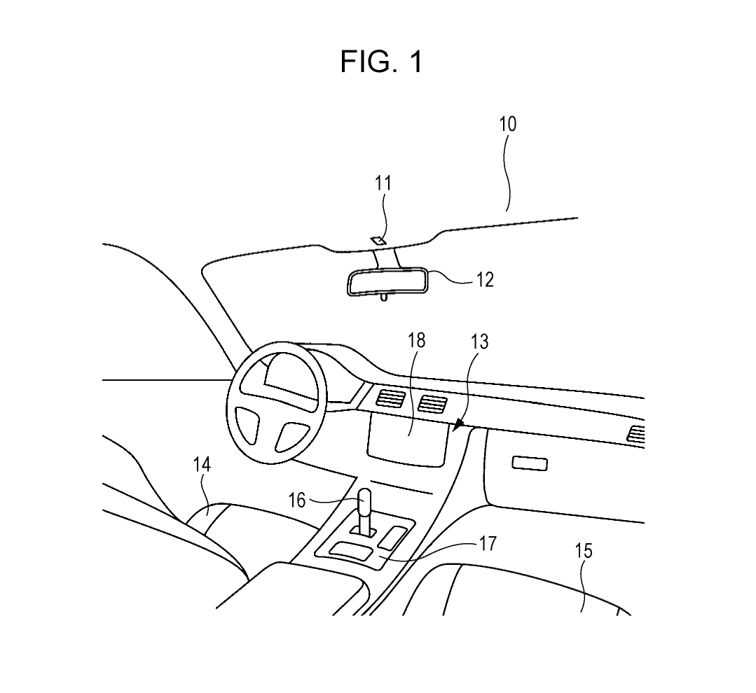

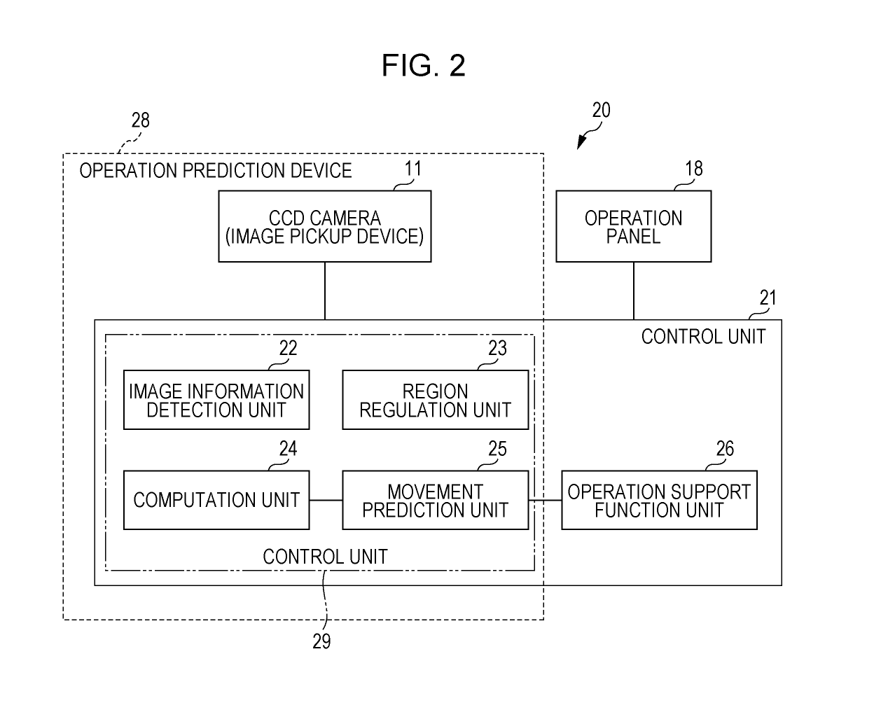

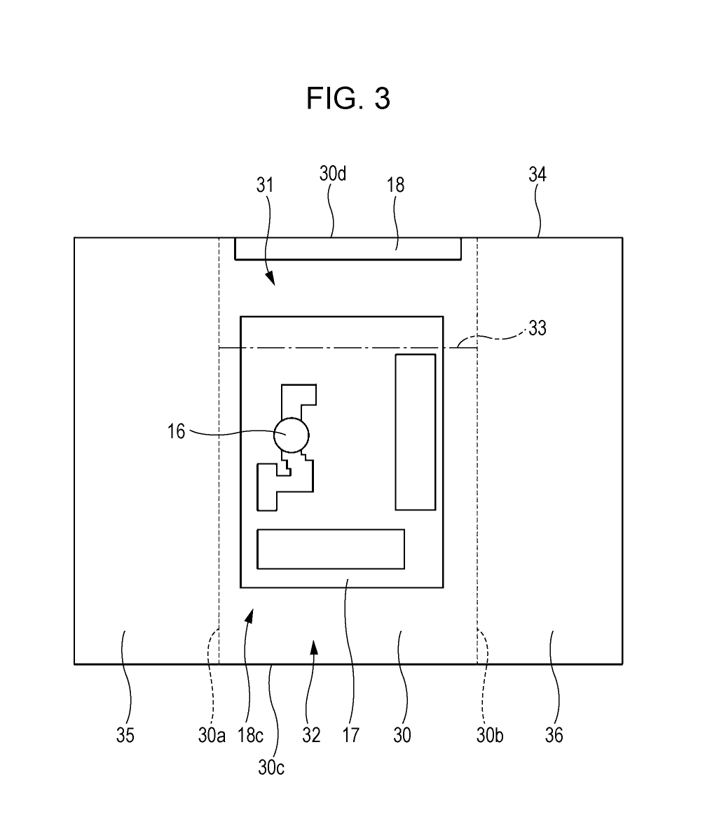

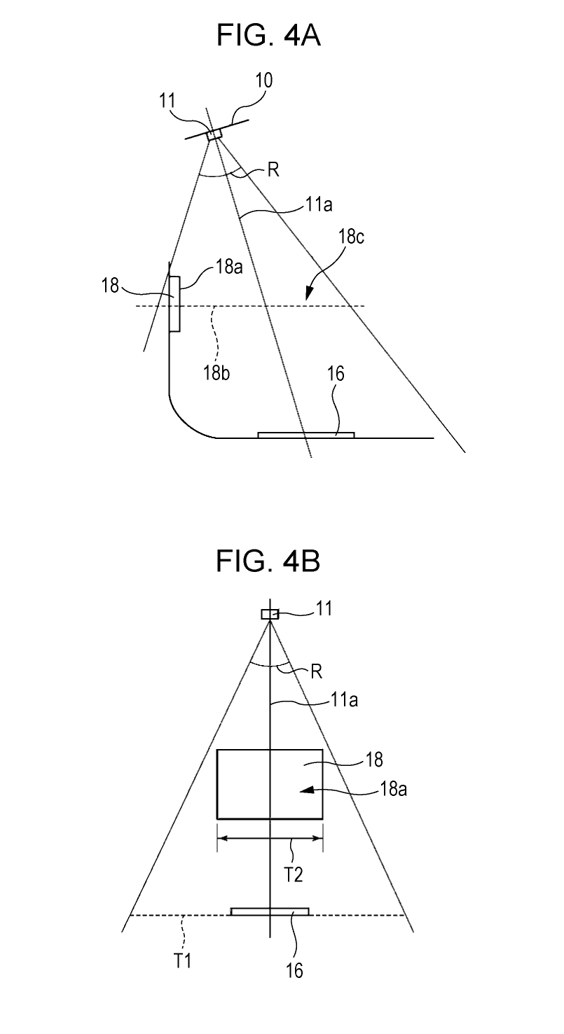

FIG. 1 is a partial schematic diagram illustrating the inside of a vehicle provided with an input apparatus of an exemplary embodiment. FIG. 2 is a block diagram of the input apparatus of an exemplary embodiment. FIG. 3 is a schematic diagram illustrating an image captured by a CCD camera (image pickup device). FIG. 4A is a schematic diagram illustrating a side view of the image pickup device, an operation panel, and the range of an image captured by the image pickup device. FIG. 4B is a schematic diagram illustrating a front view of the image pickup device, the operation panel, and the range of an image captured by the image pickup device.

FIG. 1 illustrates a region near the front seats of a vehicle. Although the vehicle illustrated in FIG. 1 is a left-hand drive vehicle, the input apparatus of the present disclosure can be also applied to a right-hand drive vehicle.

Referring to FIG. 1, a CCD camera (image pickup device) 11 may be attached to a ceiling 10 of the inside of the vehicle. In FIG. 1, the CCD camera 11 may be arranged near a rear view mirror 12. However, the position at which the CCD camera 11 is arranged may not be particularly limited as long as the image captured by the CCD camera 11 is at least a region in front of an operation panel 18. Although the CCD camera 11 may be used, the movement of an operation body can be detected at night by using a camera that can detect infrared light.

Referring again to FIG. 1, the operation panel 18 and a center operation unit 17 including a shift operation unit 16 arranged between a driver seat 14 and a front passenger seat 15 may be arranged in a center console 13.

The operation panel 18, which may be, for example, a capacitive touch panel, can display a map for a vehicle navigation apparatus, a screen for music reproduction, and the like. An operator can perform an input operation directly on the screen of the operation panel 18 using a finger or the like.

Referring to FIG. 4A, the CCD camera 11 attached to the ceiling 10 may be attached at a position where at least an image of a region in front of the operation panel 18 can be captured. Here, the region in front of the operation panel 18 refers to a space region 18c which is located on a side of the screen 18a, in a direction 18b orthogonal to the screen 18a of the operation panel 18, where an operation may be performed on the operation panel 18 using a finger or the like.

A reference symbol 11a illustrated in FIGS. 4A and 4B denotes a center axis (light axis) of the CCD camera 11, and the image capturing range is denoted by R.

As illustrate in FIG. 4A, when the image capturing range R is seen from the side (side surface side), the image capturing range R may cover the operation panel 18 and the space region 18c in front of the operation panel 18. As illustrated in FIG. 4B, when the image capturing range R is seen from the front, a width T1 of the image capturing range R (the widest width of the captured image) may be larger than a width T2 of the operation panel 18.

Referring to FIG. 2, an input apparatus 20 of an exemplary embodiment may include the CCD camera (image pickup device) 11, the operation panel 18, and a control unit 21.

Referring again to FIG. 2, the control unit 21 may includes an image information detection unit 22, a region regulation unit 23, a computation unit 24, a movement prediction unit 25, and an operation support function unit 26.

Here, although the control unit 21 is illustrated as a one unit in FIG. 2, for example, by providing the control unit 21 in a plurality, the image information detection unit 22, the region regulation unit 23, the computation unit 24, the movement prediction unit 25, and the operation support function unit 26 illustrated in FIG. 2 may be grouped, and integrated, into a plurality of control units.

In other words, the image information detection unit 22, the region regulation unit 23, the computation unit 24, the movement prediction unit 25, and the operation support function unit 26 may be appropriately and selectively integrated in control units.

Note that the CCD camera (image pickup device) 11 and a control unit 29 formed of the image information detection unit 22, the region regulation unit 23, the computation unit 24, and the movement prediction unit 25, illustrated in FIG. 2 may form a movement prediction device 28. The input apparatus 20 may be formed of a vehicle system in which the movement prediction device 28 is integrated into a vehicle in such a manner as to be able to transmit and receive a signal to and from the operation panel 18.

The image information detection unit 22 may obtain image information captured by the CCD camera 11. Here, image data may be electronic information of an image obtained by image capturing. FIG. 3 illustrates an image 34 captured by the CCD camera 11. As illustrated in FIG. 3, the image 34 may include the operation panel 18, the space region 18c in front of the operation panel 18. The image 34 also may include, in front of the operation panel 18, the center operation unit 17 in which the shift operation unit 16 and the like are arranged. Further, the image 34 in FIG. 3 may include regions 35 and 36 on the left and right sides of the operation panel 18 and the center operation unit 17. The left-side region 35 may be a region on the driver seat side and the right-side region 36 may be a region on the front passenger seat side. In FIG. 3, images included in the left-side and right-side regions 35 and 36 are omitted. Note that there are no particular restrictions on the types of the CCD camera 11, the number of pixels, and the like.

The region regulation unit 23 illustrated in FIG. 2 may identify a region used to track the movement locus of an operation body and to predict the movement of the operation body, on the basis of image information obtained by the CCD camera 11.

The central image region located in front of the operation panel 18 in the image 34 illustrated in FIG. 3 may be identified as a movement detection region 30. In other words, the movement detection region 30 may be a region surrounded by a plurality of sides 30a to 30d, and the left-side and right-side regions 35 and 36 may be excluded from the movement detection region 30. The boundaries (sides) 30a and 30b between the movement detection region 30 and the left-side and right-side regions 35 and 36 illustrated in FIG. 3 are illustrated with dotted lines. In FIG. 3, although the sides 30c and 30d are the end portions of the image 34 in the front and back direction, the sides 30c and 30d may be arranged within the image 34.

The entirety of the image 34 illustrated in FIG. 3 may be defined as the movement detection region 30. However, in this case, there will be an increase in the amount of computation required for the tracking of the movement locus and movement prediction regarding an operation body, leading to a delay in the movement prediction and a decrease in the lifetime of the apparatus. In addition, production cost will increase to enable a lot of computation. Hence, a limited region may be used as the movement detection region 30 rather than using the entire image 34.

In the embodiment illustrated in FIG. 3, the movement detection region 30 may be divided into two sections 31 and 32. A boundary 33 between the section 31 and the section 32 is illustrated with a one-dot chain line. When the movement detection region 30 is divided into a plurality of sections, any method of the division may be allowed. Division into more than two sections also may be allowed. Since the section 31 is near the operation panel 18 and the movement status of an operation body within the section 31 is important for performing prediction of the movement of an operation body and operation support for the operation panel 18, the section 31 may be divided into smaller sections, thereby enabling determination of more detailed execution timing of operation support actions.

Hereinafter, the section 31 will be called a first section and the section 32 will be called a second section. As illustrated in FIG. 3, the first section 31 may include the operation panel 18 in the image and is a region closer to the operation panel 18 than the second section 32.

The computation unit 24 illustrated in FIG. 2 may compute the movement locus of an operation body within the movement detection region 30. The movement locus of an operation body may be computed using the following method, although not limited to this.

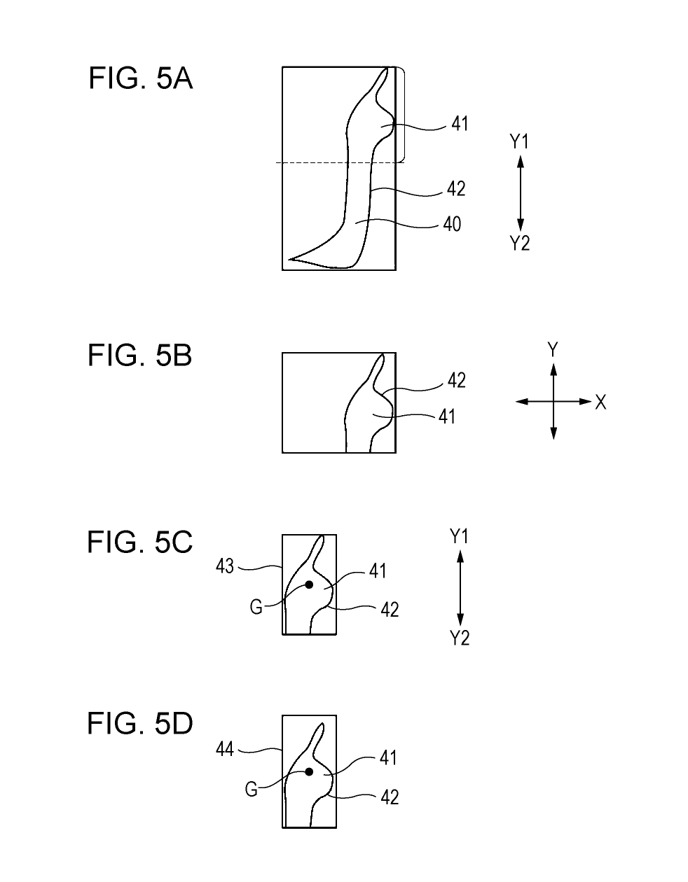

In FIG. 5A, information about an outline 42 of an arm 40 and a hand 41 may be detected. In order to detect the outline 42, the size of an image captured by the CCD camera 11 may be reduced to reduce the amount of computation, and then the image may be converted into a monochrome image to perform recognition processing. At this time, in an exemplary embodiment, the amount of computation may be reduced by reducing the size of an image so as to enable fast processing, although recognition processing for an operation body may be performed with higher accuracy if more detailed image is used. After the image has been converted into a monochrome image, the operation body may be detected on the basis of a change in luminance. Note that when an infrared detection camera is used, the processing for conversion into a monochrome image is not required. Then, for example, a motion vector is detected by computing an optical flow using the current frame and a frame prior to the current frame. At this time, the motion vector may be averaged over 2×2 pixels to reduce the influence of noise. When the motion vector has a vector length (amount of movement) larger than or equal to a predetermined length, the outline 42 of the arm 40 and the hand 41 appearing in the movement detection region 30 is detected as an operation body, as illustrated in FIG. 5A.

Next, as illustrated in FIG. 5A, the image may be trimmed by limiting the vertical length (Y1-Y2), whereby the region of the hand 41 may be estimated, as illustrated in FIG. 5B. At this time, by computing the sizes of the portions of the operation body on the basis of the outline 42, a region having portion sizes larger than or equal to a predetermined value may be determined to be an effective region. Here, the reason why a lower limit is provided is to remove an arm utilizing the fact that a hand is wider than an arm, in general. The reason why an upper limit is not provided is that when a body is also included in the movement detection region 30 as a captured image, motion vectors are generated in a considerably wide area and, hence, detection becomes impossible in some cases if an upper limit is provided. Then a region circumscribing the outline 42 in the effective region may be detected. For example, in FIG. 5B, the X-Y coordinates forming the whole outline 42 may be checked and the maximum and minimum values of the X coordinates are obtained, whereby the width (length in the X direction) of the effective region is reduced, as illustrated in FIG. 5C. In this manner, a minimum rectangular region 43 circumscribing the outline 42 may be detected and it may be determined whether or not the vertical length (Y1-Y2) of the minimum rectangular region 43 (effective region) is smaller than or equal to a predetermined threshold. When it is determined that the length is smaller than or equal to the predetermined threshold, the position of a center of gravity G may be computed in this effective region.

When it is determined that the vertical length (Y1-Y2) of the minimum rectangular region 43 (effective region) is larger than the predetermined threshold, the vertical length of an arm with the lower limit size may be limited within a predetermined range from the Y1 side, and the image is trimmed (FIG. 5D). In the trimmed image, a minimum rectangular region 44 circumscribing the outline 42 is detected and a region obtained by extending the minimum rectangular region 44 in all the directions by several pixels may be made to be an estimated hand region. By making the extended region be an estimated hand region, it becomes possible to again recognize a region of the hand 41 that has been unintentionally removed in the process of detecting the outline 42. For this estimated hand region, the determination of an effective region described above is again performed. When the vertical length of the effective region is smaller than or equal to the threshold, the center of the effective region may be defined as the center of gravity G of the hand 41. The method of computing the position of the center of gravity G is not limited to the one described above, and a known algorithm may be used instead. However, since prediction of the movement of an operation body is performed while a vehicle is moving, fast computation of the position of the center of gravity G may be required, and very high accuracy is not required for the computed position of the center of gravity G. It is important to be able to continuously compute the motion vector of a position defined as the center of gravity G. By using this motion vector, it becomes possible to reliably predict the movement even when it is difficult to tell the shape of a hand, which is an operation body, for example, under the condition that the state of the surrounding lighting continues to change. In addition, as described above, information about the outline 42 and information about a region circumscribing the outline 42 are both used in the processing, whereby a hand and an arm can be reliably distinguished from each other.

While the motion vector is being detected as described above, the motion vector of the center of gravity G of a moving body (here, the hand 41) may be continuously computed and the motion vector of the center of gravity G can be continuously obtained as the movement locus of the moving body.

The movement prediction unit 25 illustrated in FIG. 2 may predict a position to which an operation body will move next on the basis of the movement locus of the operation body. For example, the movement prediction unit 25 may predict where on the screen 18a of the operation panel 18 an operation body will reach if the motion continues, on the basis of whether the movement locus of the operation body is heading straight toward the operation panel 18 or the movement locus of the operation body is in a diagonal direction with respect the operation panel 18.

The operation support function unit 26 illustrated in FIG. 2 may perform operation support for the operation panel 18 on the basis of the predicted movement of an operation body. The term “operation support” in the exemplary embodiments refers to controlling/adjusting the manner in which an input operation or an input operation position is displayed to allow good operability and safety to be realized. Specific examples of the operation support will be described later.

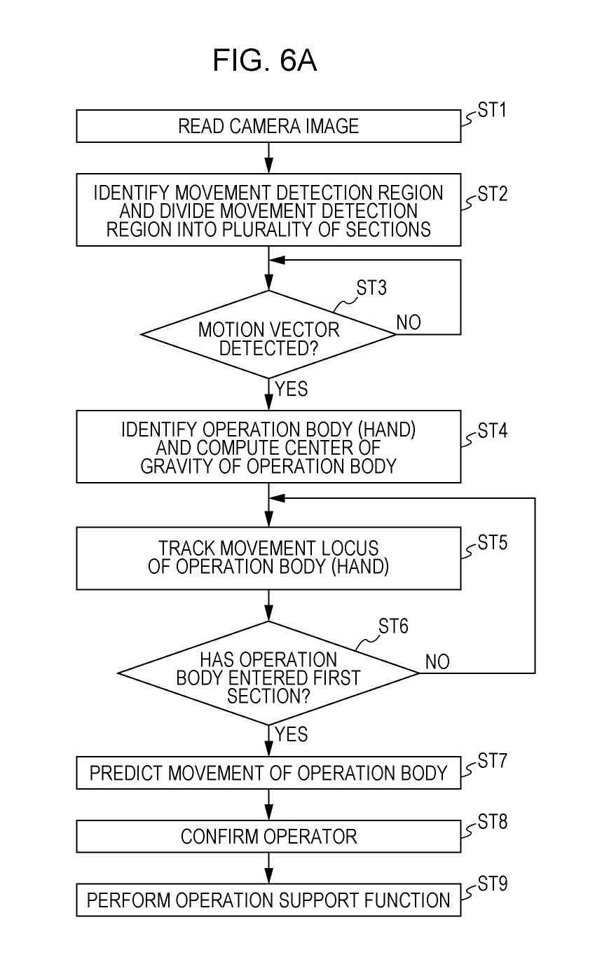

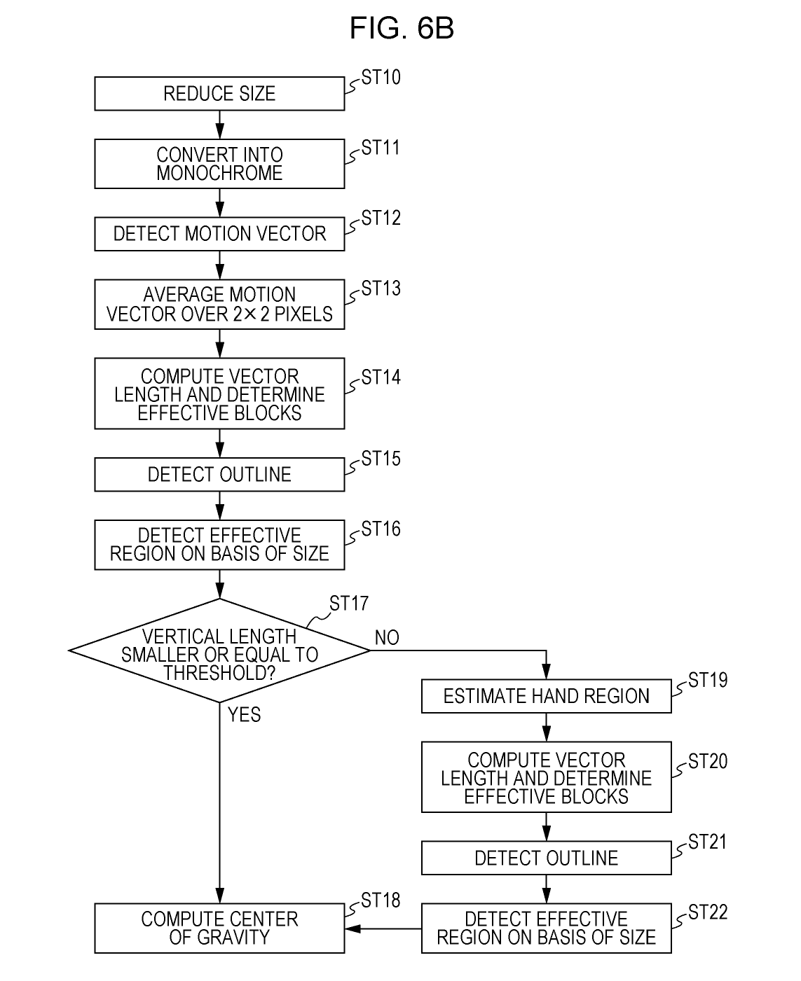

Hereinafter, processing steps from reading of image information to execution of operation support will be described with reference to a flowchart illustrated in FIG. 6A.

First in step ST1 illustrated in FIG. 6A, image information of the CCD camera 11 may be read from the image information detection unit 22 illustrated in FIG. 2. Then in step ST2, the movement detection region 30 may be identified on the basis of the image information using the region regulation unit 23 illustrated in FIG. 2, and the movement detection region 30 may be divided into the sections 31 and (refer to FIGS. 5A to 5D).

The entirety of the image 34 illustrated in FIG. 3 may be defined as the movement detection region 30. However, to reduce the amount of computation (amount of calculation), at least a region in front of the operation panel 18 may be defined as the movement detection region 30.

Then in step ST3 illustrated in FIG. 6A, a motion vector may be detected using the computation unit 24 illustrated in FIG. 2. Although detection of a motion vector is illustrated only in step ST3 illustrated in FIG. 6A, detection may be performed between a prior frame and the current frame as to whether or not a motion vector exists.

In step ST4 illustrated in FIG. 6A, an operation body (hand) may be identified and the position of the center of gravity G of the operation body (hand) is computed using the computation unit 24, as illustrated in FIGS. 5A to 5D.

In an exemplary embodiment, a hand portion may be used as an operation body as illustrated in FIGS. 5A to 5D. A flowchart from processing for estimating a hand portion to processing for computing the position of the center of gravity G is illustrated in FIG. 6B.

In FIG. 6B, after an image captured by the CCD camera 11 illustrated in FIG. 6A has been read, the size of the image is reduced in step ST10, and then in step ST11, processing for converting the image into a monochrome image may be performed to perform recognition processing. In step ST12, an optical flow may be computed using, for example, the current frame and a frame prior to the current frame, thereby detecting a motion vector. Note that this detection of an optical vector is shown also in step ST3 illustrated in FIG. 6A. In FIG. 6B, the flow proceeds to the next step ST13 assuming that a motion vector has been detected.

In step ST13, the motion vector may be averaged over 2×2 pixels. At this time, the image includes, for example, 80×60 blocks.

Then in step ST14, a vector length (amount of movement) for each block may be computed. When the vector length is larger than a predetermined value, the block may be determined to be a block with effective movement.

Then, the outline 42 of an operation body may be detected as illustrated in FIG. 5A (step ST15).

Next in step ST16, the sizes of the portions of the operation body may be computed on the basis of the outline 42, and a region having portion sizes larger than or equal to a predetermined value may be determined to be an effective region. In the effective region, a region circumscribing the outline 42 is detected. As described with reference to FIG. 5B, for example, the X-Y coordinates forming the whole outline 42 may be checked and the maximum and minimum values of the X coordinates are obtained, whereby the width (length in the X direction) of the effective region is reduced, as illustrated in FIG. 5C.

In this manner, the minimum rectangular region 43 circumscribing the outline 42 may be detected, and in step ST17, it may be determined whether or not the vertical length (Y1-Y2) of the minimum rectangular region 43 (effective region) is smaller than or equal to a predetermined threshold. When it is determined that the length is smaller than or equal to the predetermined threshold, the position of a center of gravity G is computed in this effective region, as illustrated in step ST18.

When it is determined in step ST17 that the vertical length (Y1-Y2) of the minimum rectangular region 43 (effective region) may be larger than the predetermined threshold, the vertical length of an arm with the lower limit size is limited within a predetermined range from the Y1 side, and the image is trimmed (refer to FIG. 5D). Then, as illustrated in step ST19, in the trimmed image, the minimum rectangular region 44 circumscribing the outline 42 may be detected and a region obtained by extending the minimum rectangular region 44 in all the directions by several pixels may be made to be an estimated hand region.

Then, in the estimated hand region, processing similar to that of steps ST14-ST16 is performed in steps ST20-ST22, and in step ST18, the center of the effective region may be defined as the center of gravity G of the hand 41.

After the position of the center of gravity G of an operation body (hand) has been computed as described above, in step ST5 illustrated in FIG. 6A, the movement locus of the operation body (hand) may be tracked. Here, the tracking of the movement locus may be achieved by using the motion vector of the center of gravity G. The term “tracking” refers to a state in which the movement of a hand which entered the movement detection region 30 continues to be tracked. As described above, the tracking of the movement locus may be achieved by using the motion vector of the center of gravity G of the hand. Since the position of the center of gravity G is obtained when, for example, the motion vector may be detected by computing the optical flow using the current frame and a frame prior to the current frame, there is an interval between the operations of obtaining the position of the center of gravity G. The tracking in an exemplary embodiment may correspond to tracking which may include such an interval between the operations of obtaining the position of the center of gravity G.

The tracking of an operation body may be started when it is detected that the operation body has entered the movement detection region 30. However, the tracking of the movement locus of the operation body may be started a little later than this, for example, after it has been determined that the operation body reached near the boundary 33 between the first section 31 and the second section 32. In this manner, the tracking of the movement locus may be started at any appropriately chosen point of time. Note that in the embodiments described below, the tracking of the movement locus is started when it is determined that the operation body has entered the movement detection region 30.

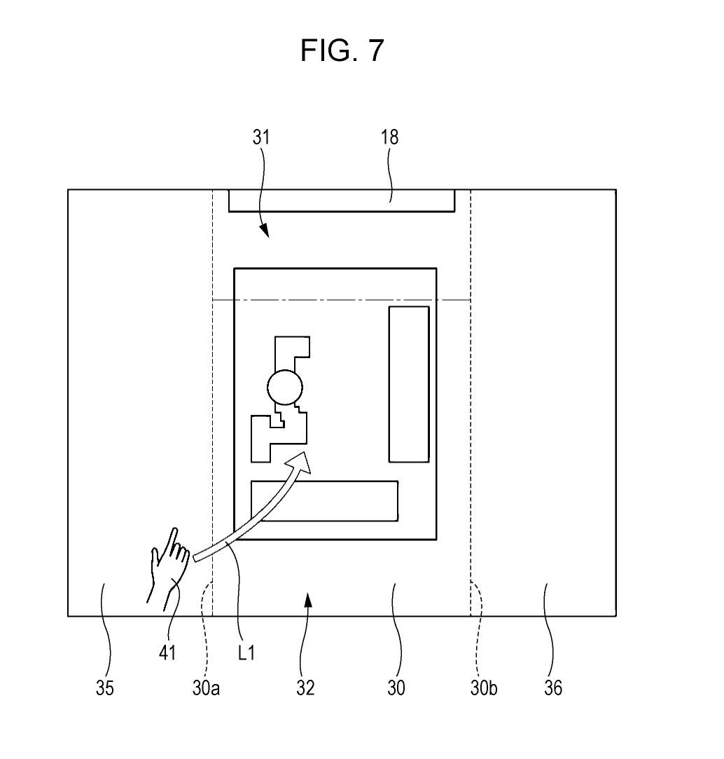

FIG. 7 illustrates a state in which a driver extended the hand 41 toward the operation panel 18 to operate the operation panel 18.

An arrow L1 illustrated in FIG. 7 represents the movement locus (hereinafter called a movement locus L1) of the hand 41 in the movement detection region 30.

Referring to FIG. 7, the movement locus L1 of the hand 41 is moving in the second section 32, which is farther from the operation panel 18, toward the first section 31 among the sections 31 and 32 forming the movement detection region 30.

In step ST6 illustrated in FIG. 6A, it may be detected whether or not the movement locus L1 has entered the first section 31 closer to the operation panel 18. When the movement locus L1 has not entered the first section 31, the flow goes back to step ST5, where the movement locus L1 of the hand 41 continues to be tracked through a routine of steps ST3 to ST5 illustrated in FIG. 6A. In this manner, the routine of steps ST3 to ST5 continues during prediction of movement also after the flow has returned to step ST5, although not illustrated in FIG. 6A.

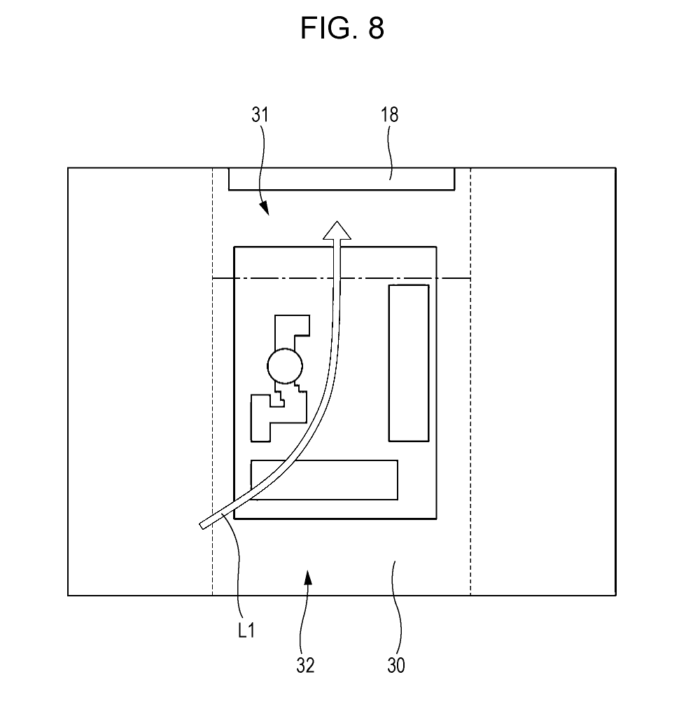

Referring to FIG. 8, when the movement locus L1 of the hand 41 has entered, from the second section 32, the first section 31, which is closer to the operation panel 18, the condition of step ST6 is satisfied and the flow proceeds to step ST7, in FIG. 6A. Note that it can be determined whether or not the movement locus L1 has entered the first section 31 using the computation unit 24 illustrated in FIG. 2. Alternatively, a determination unit that determines whether or not the movement locus L1 has entered the first section 31 may be provided in the control unit 21, separately from the computation unit 24.

In step ST7 illustrated in FIG. 6A, the movement of the hand (operation body) 41 may be estimated on the basis of the movement locus L1. In other words, on the basis of the movement locus L1 extending from the second section 32 to the first section 31, the movement prediction unit 25 illustrated in FIG. 2 may predict where in the movement detection region 30 the hand 41 will reach (where on the screen 18a of the operation panel 18 the hand 41 will reach) if the current movement locus is maintained. In addition, various responses may be possible. For example, by dividing the sections further into smaller sections in accordance with the position of an operation member such as the shift operation unit 16 existing in the movement detection region 30, when it is predicted that the shift operation unit 16 is going to be operated, the shift operation unit 16 may be illuminated using separately provided illumination means.

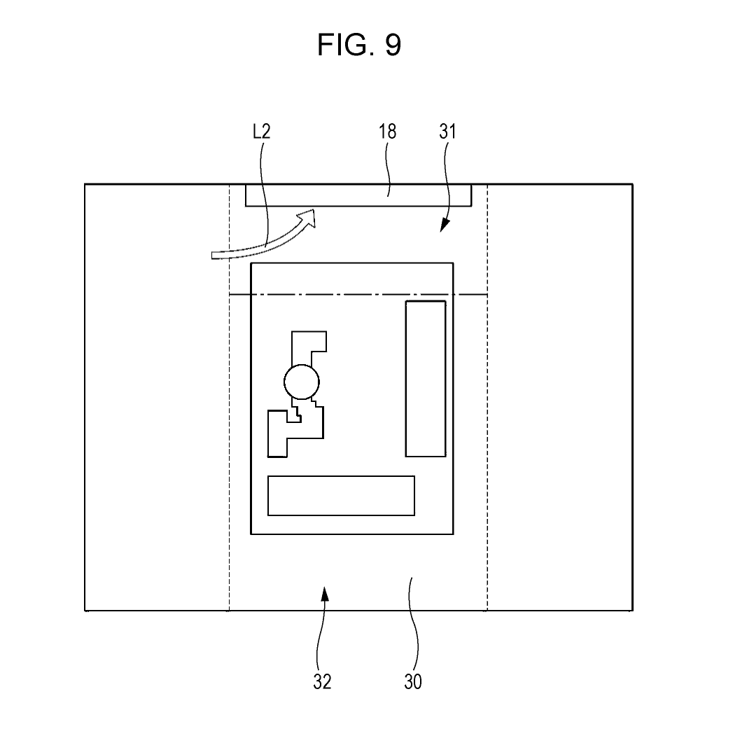

Although the movement locus L1 of the hand 41 is moving from the second section 32 to the first section 31 of the movement detection region 30 in FIG. 8, for example, the movement locus L2 of the hand 41 may directly enter the first section 31 without passing through the second section 32 of the movement detection region 30, as illustrated in FIG. 9.

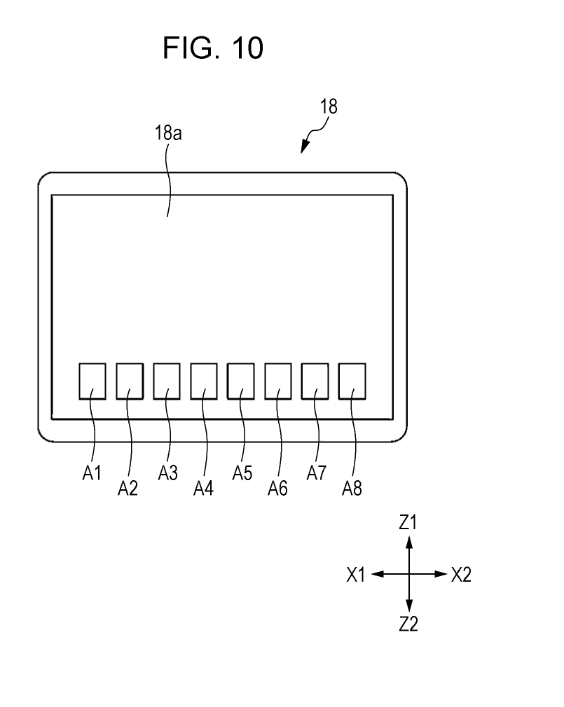

FIG. 10 illustrates the screen 18a of the operation panel 18. Referring to FIG. 10, a plurality of icons A1 to A8 may be arranged at the bottom of the operation panel 18 in the horizontal direction (X1-X2), which is perpendicular to the height direction (Z1-Z2) of the operation panel 18. A portion above the icons A1 to A8 may be a portion in which a map in a vehicle navigation apparatus is displayed or information about music reproduction is displayed.

Note that a configuration may be employed in which, for example, the icons A1 to A8 may be arranged in the height direction (Z1-Z2) or some of the icons are arranged in the horizontal direction and the rest of the icons are arranged in the height direction, unlike the arrangement of the icons A1 to A8 illustrated in FIG. 10.

However, in the configuration in which the icons are arranged in the height direction, when the movement locus L1 or a movement locus L2 enters the first section 31, as illustrated in FIG. 8 or FIG. 9 or when the movement locus L1 is in a stage where the movement locus L1 is located in the second section 32 as illustrated in FIG. 7, it may be necessary to detect the vertical position of the hand 41. Here, although the method of computing the vertical position is not limited, the vertical position of the hand 41 can be estimated, for example, on the basis of the areas of the minimum rectangular regions 43 and 44 containing the outline 42 of the hand 41 in FIGS. 5C and 5D. In other words, as illustrated in FIG. 3, the image 34 captured by the CCD camera 11 may be a plane and only two-dimensional information is obtained and, hence, the vertical position of the hand 41 can be found on the basis of the fact that, the larger the areas of the minimum rectangular regions 43 and 44, the higher (closer to the CCD camera 11) the vertical position of the hand 41. At this time, to compute the vertical position of the hand 41 on the basis of comparison of the area of the hand 41 with the reference area of the hand 41 (for example, the area of the hand 41 when the hand 41 performed an operation at the center of the operation panel 18), initial setting may be performed to measure the reference area. As a result, the vertical position of the movement locus of the hand 41 can be estimated.

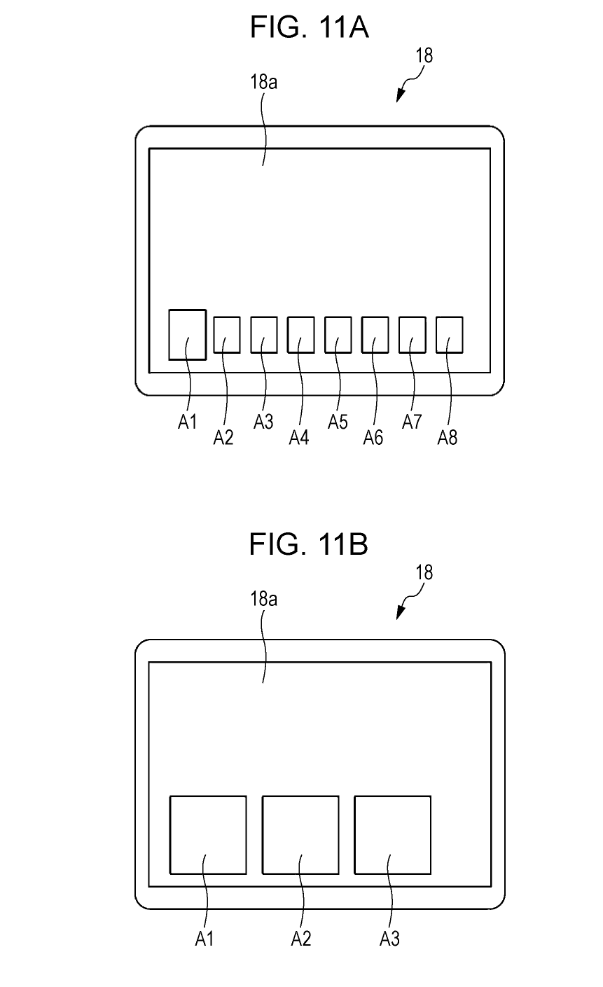

It is assumed that an input operation on the icon A1 illustrated in FIG. 10 has been predicted on the basis of the movement locus of the hand 41 (operation body). Then, the movement prediction information may be transmitted to the operation support function unit 26, where after an operator has been confirmed in step ST8 illustrated in FIG. 6A, operation support for the operation panel 18 is performed, as illustrated step ST9 in FIG. 6A. For example, as illustrated in FIG. 11A, before the screen 18a is touched with a finger, the displayed icon A1, for which an input operation has been predicted, may be enlarged. This is one form of highlighting of the icon A1, for which an input operation has been predicted.

Referring to FIG. 11B, when an input operation for the icon A2 illustrated in FIG. 10 has been predicted on the basis of the movement locus of the hand 41 (operation body), the icon A1 and an icon A3 located near (on the two sides of) the icon A2 may be enlarged and displayed together with the icon A2 while deleting the rest of the icons A4 to A8 from the screen. In this manner, by displaying only a plurality of enlarged icons neighboring an icon for which an operation has been predicted, displaying of further-enlarged icons becomes possible, whereby misoperations can be suppressed. In particular, by enlarging and displaying only icons for which a driver is predicted to be going to perform an input operation while driving, a misoperation such as wrongly pressing neighboring icons can be suppressed even when the vehicle jolts.

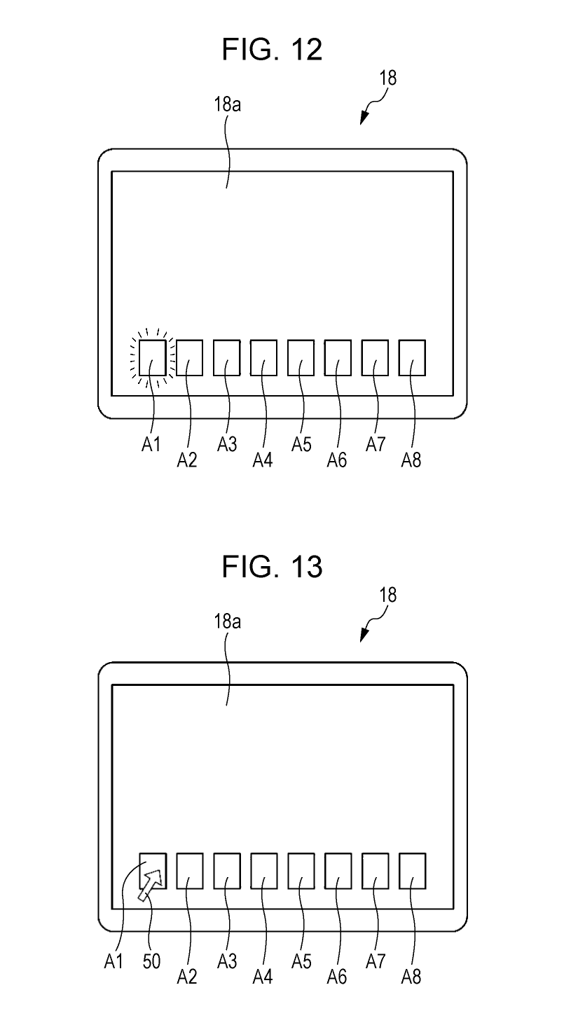

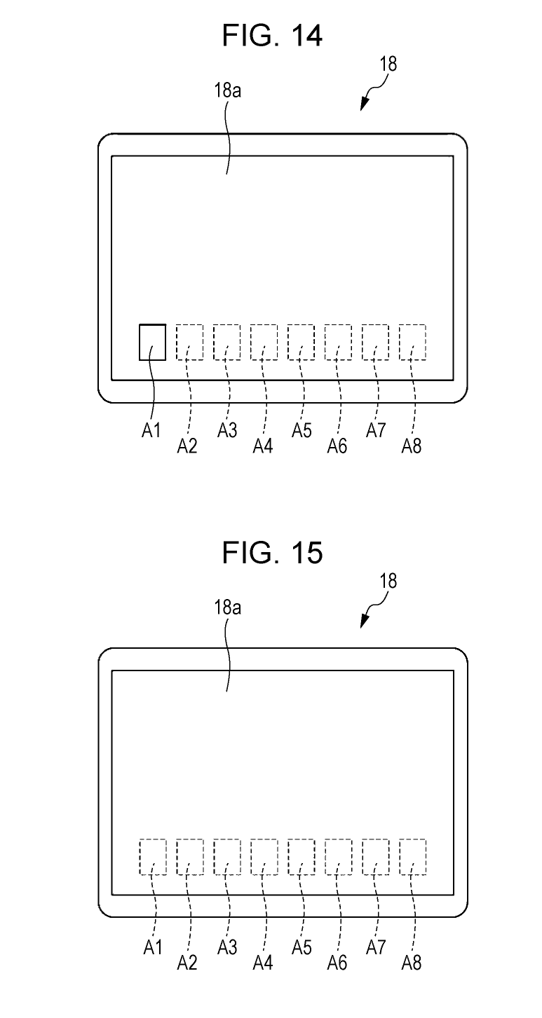

In an exemplary embodiment, configurations, other than those of FIGS. 11A and 11B, may be employed in which the icon A1 is lit or made to flash as illustrated in FIG. 12, a cursor 50 or the like is laid on the icon A1 as illustrated in FIG. 13 to show that the icon A1 has been selected, or the icons A2 to A8 other than the icon A1 are grayed out to emphasize that an input operation can be performed only for the icon A1 as illustrated in FIG. 14.

Referring to FIG. 6A, an operator may be confirmed in step ST8. When the operator has been identified as a driver, for example, all the icons A1 to A8 on the screen 18a of the operation panel 18 may be grayed out as one form of operation support for increasing safety during driving, as illustrated in FIG. 15. In the example illustrated in FIG. 15, by obtaining the speed of the vehicle from a vehicle speed sensor (not illustrated), the icons A1 to A8 may be controlled so as to be grayed out as illustrated in FIG. 15 when the speed is higher than or equal to a predetermined speed and the operator has been recognized as the driver.

In the control unit 21, it can be easily and appropriately determined whether the operator is the driver or a passenger other than the driver by preferably tracking the movement locus L1 from a position through which the movement locus L1 entered the boundaries (sides) 30a and 30b between the movement detection region 30 and the left-side and right-side regions 35 and 36.

In other words, as illustrated in FIG. 7, the hand 41 can be identified as the hand of the driver by detecting that the hand 41 has entered the movement detection region 30 from the boundary 30a between the movement detection region 30 and the left-side region 35, which is the driver side (since FIG. 1 illustrates the case of left hand driving).

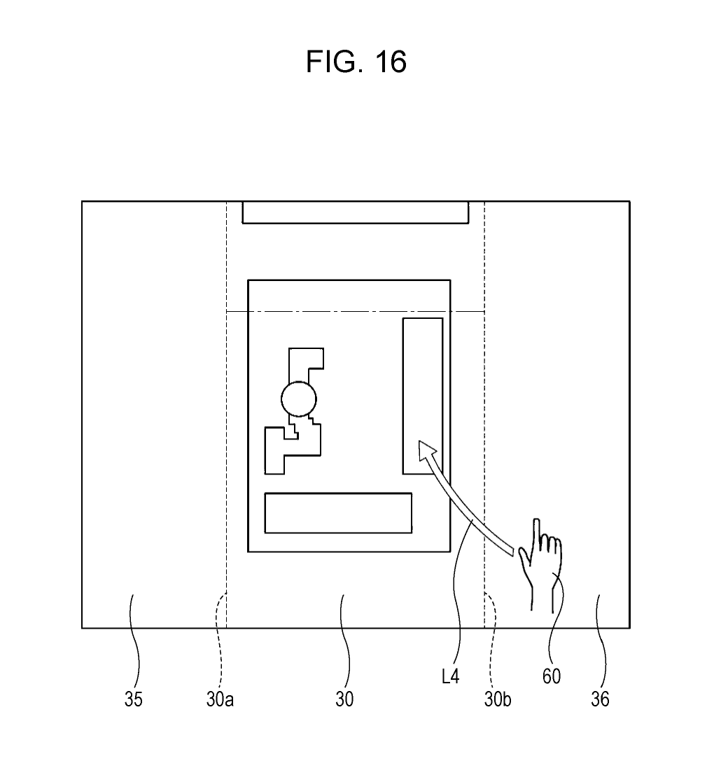

Referring to FIG. 16, a hand 60 can be identified as the hand of a passenger in the front passenger seat when a movement locus L4 of the hand 60 extends into the movement detection region 30 from the boundary 30b between the movement detection region 30 and the right-side region 36, which is the front passenger seat side.

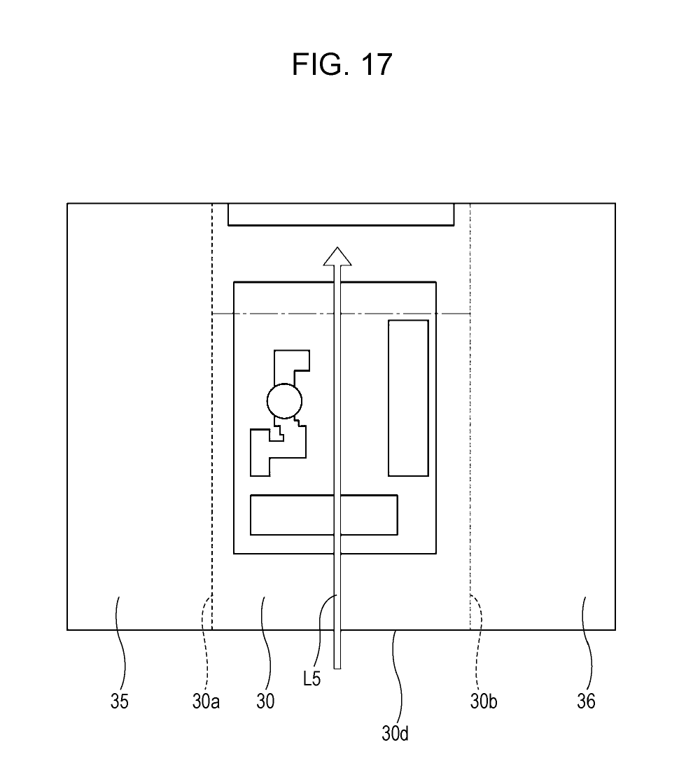

Referring to FIG. 17, the operator can be identified as a passenger in the back seat when a movement locus L5 enters the movement detection region 30 from the position of the side 30d, which is farthest from the operation panel 18 in the movement detection region 30.

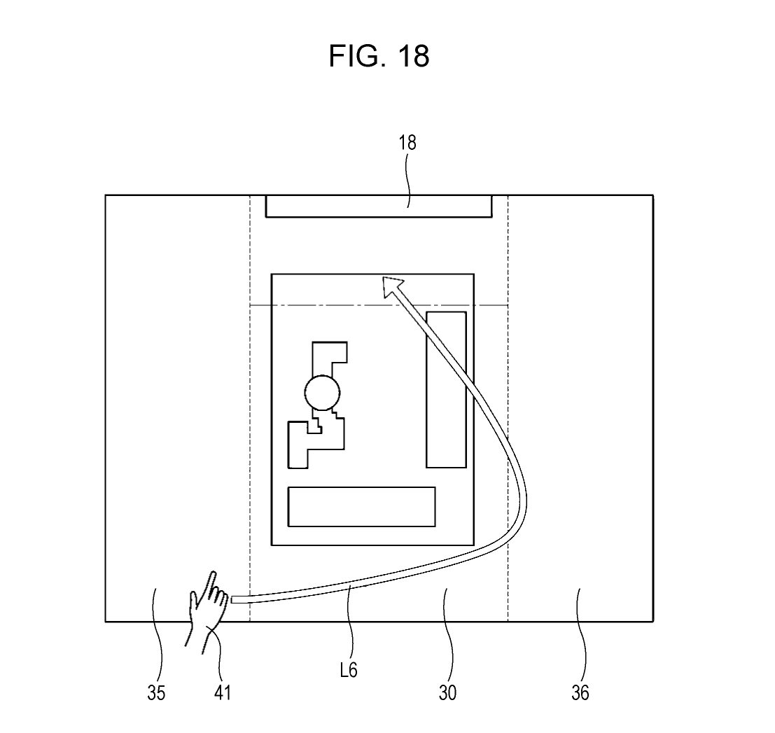

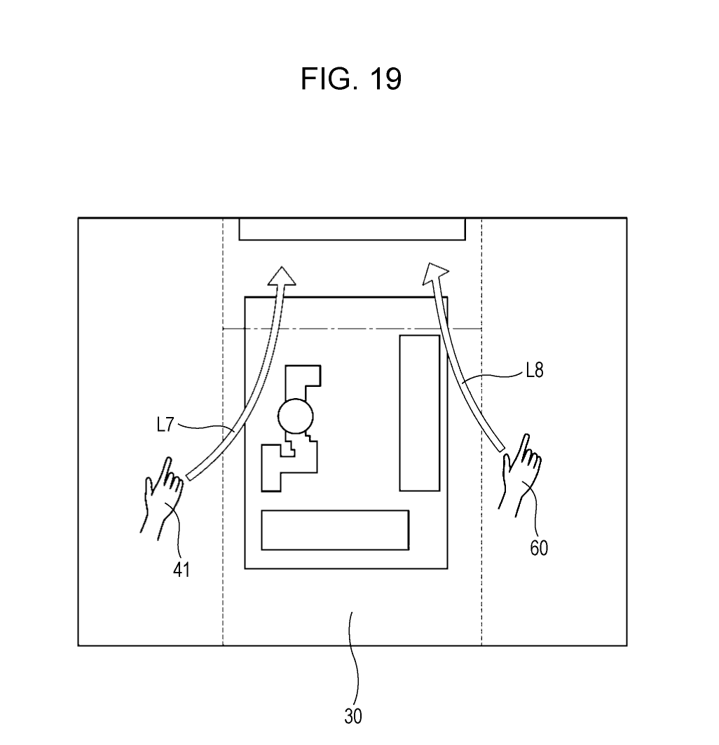

In an exemplary embodiment, by tracking the movement locus of an operation body, even when the driver, for example, tries to operate the operation panel 18 by extending the arm through the front passenger seat, as illustrated in FIG. 18, the operator can be identified as the driver by tracking a movement locus L6 of the hand 41 (operation body), as illustrated in FIG. 18.

In an exemplary embodiment, control may be performed in such a manner that input operation functions are different in accordance with whether the operator is the driver or a passenger other than the driver. For example, control may be performed in such a manner that emphasized display of the icon A1 illustrated in FIGS. 11A to 14 is performed when the operator is a passenger in the front passenger seat, and all the icons A1 to A8 illustrated in FIG. 15 are grayed out when the operator is the driver. As a result, safety during driving can be increased. Note that when the operator is identified as a passenger in the back seat, for example, safety during driving can be increased by graying out all the icons A1 to A8 similarly to the case in which the operator is identified as the driver. In this manner, the emphasized display on the operation panel 18 may be performed only when the operator is identified as a passenger in the front passenger seat.

When the operator is identified as the driver in step ST8 illustrated in FIG. 6A, it is preferable to limit an input operation in comparison with the case in which the operator is a passenger in the front passenger seat in order to increase safety. For example, when the vehicle is moving at a speed higher than or equal to a predetermined speed, control may be performed in such a manner that all the icons are grayed out to disable an input operation.

Also when the icon A1 is enlarged and displayed as illustrated in FIGS. 11A and 11B, comfortable operability and safety are increased by displaying a further enlarged icon A1 in the case where the operator is the driver, compared with the case where the operator is a passenger in the front passenger seat. Such a configuration is also an example in which control is performed in such a manner that input operation functions are different in accordance with whether the operator is the driver or a passenger other than the driver.

Referring to FIG. 19, when a movement locus L7 of the hand 41 of the driver and a movement locus L8 of the hand 60 of a passenger in the front passenger seat are both detected in the first section 31 of the movement detection region 30, operation support may be performed in such a manner that preference is given to prediction of the movement of the passenger in the front passenger seat in order to increase safety during driving.

The operation support for the operation panel 18 may include, for example, a configuration in which the input automatically enters an on state or an off state without touching the operation panel 18, on the basis of the prediction of the movement of an operation body.

As illustrated in FIGS. 11A to 14, after the icon A1, for which an input operation is predicted, has been displayed in an emphasized mode, the input operation for the icon A1 may be completed before a finger touches the icon A1 when the hand 41 further approaches the operation panel 18.

In an exemplary embodiment, icons are illustrated as example objects to be displayed in an emphasized mode. However, objects to be displayed in an emphasized mode may be displayed objects other than the icons or may be objects displayed in an emphasized mode for predicted operation positions.

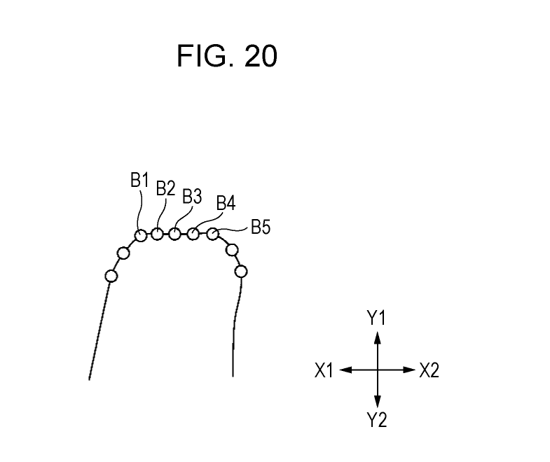

FIG. 20 illustrates a method of detecting a finger. First, the coordinates of the outline 42 of the hand 41 may be obtained in FIG. 5B, and points B1 to B5 which may be located furthest in the Y1 direction are listed up, as illustrated in FIG. 20. Since the Y1 direction points to the operation panel 18, the points B1 to B5 located furthest in the Y1 direction may be estimated to be at the tip of the finger. Among the points B1 to B5, the point B1, which may be located furthest in the X1 direction, and the point B5, which is located furthest in the X2 direction, are obtained. Then the coordinates of the middle point (here, the position of the point B3) between the point B1 and the point B5 may be estimated to be the finger position. In an exemplary embodiment, by making the operation body be a finger, control may be performed in such a manner that the movement prediction may be performed by tracking the movement locus of the finger. As a result of using the movement locus of a finger, more detailed movement prediction becomes possible.

Further, the left hand and the right hand may be distinguished from each other, or the front and back of a hand may be distinguished from each other.

Even when an operation body is in a halt state in the movement detection region 30, the movement locus can be immediately tracked when the operation body starts to move later, by obtaining the halt state whenever necessary using a center of gravity vector or by maintaining the position of the center of gravity G in a halt state for a predetermined time.

According to the movement prediction device 28 (refer to FIG. 2), the movement detection region 30 may be identified using image information obtained by the CCD camera (image pickup device) 11, and the control unit 29 may be provided which can track the movement locus of an operation body that moves in the movement detection region 30. In an exemplary embodiment, movement prediction may be realized on the basis of the movement locus of the operation body. Hence, when the movement prediction device 28 may be built in a vehicle and the movement prediction device 28 and the operation panel 18 form the input apparatus 20, the prediction of an operation for the operation panel 18 is possible in a region in front of the operation panel 18 through which an operation for the operation panel 18 is performed. As a result, operability different from that of the related art, quick operability, and comfortable operability can be obtained. Further, safety during driving can be increased to a level higher than that of the related art.

Since the exemplary embodiments employ a configuration in which the movement of an operation body is predicted rather than a configuration in which operation support is provided with a key input as a trigger as disclosed in the invention of Japanese Unexamined Patent Application Publication No. 2005-274409, an additional operation can be eliminated compared with the related art.

In an exemplary embodiment, since the position of the center of gravity G of an operation body may be computed and the motion vector of the center of gravity G may be tracked as the movement locus of the operation body, the tracking of the movement locus of the operation body and the movement prediction based on the movement locus can be performed easily and smoothly.

As illustrated in FIG. 5, in which the movement detection region includes not only the hand 41 portion but also the arm 40 portion, by trimming other portions except for the hand 41 portion and looking at the movement locus of the hand 41, the movement locus can be easily computed, the computation load of the control unit can be reduced, and the movement prediction is facilitated.

In an exemplary embodiment, the tracking of the movement locus of an operation body may be started from a position through which the operation body enters the movement detection region 30. In other words, by determining which of the sides 30a to 30d of the movement detection region 30 the operation body passed through to enter the movement detection region 30, it becomes easy to identify the operator.

In an exemplary embodiment, the movement detection region 30 is divided into the sections 31 and 32, and the movement prediction is performed on the basis of the fact that the movement locus of an operation body has entered the first section 31, which is close to the operation panel 18. In this manner, since the movement prediction is performed, while the movement locus of the operation body is tracked, on the basis of the fact that an operation body has entered a predetermined section, a load on the control unit for the movement prediction may be reduced and the accuracy of the movement prediction is increased.

The movement prediction device 28 illustrated in FIG. 2 may be applied to configurations other than the configuration in which the movement prediction device 28 is built in a vehicle so as to form, together with the operation panel 18, the input apparatus 20.

Accordingly, the embodiments of the present inventions are not to be limited in scope by the specific embodiments described herein. Further, although some of the embodiments of the present disclosure have been described herein in the context of a particular implementation in a particular environment for a particular purpose, those of ordinary skill in the art should recognize that its usefulness is not limited thereto and that the embodiments of the present inventions can be beneficially implemented in any number of environments for any number of purposes. Accordingly, the claims set forth below should be construed in view of the full breadth and spirit of the embodiments of the present inventions as disclosed herein. While the foregoing description includes many details and specificities, it is to be understood that these have been included for purposes of explanation only, and are not to be interpreted as limitations of the invention. Many modifications to the embodiments described above can be made without departing from the spirit and scope of the invention.

What is claimed is:

1. A movement prediction device comprising:
an image pickup device for obtaining image information; and
a control unit for performing movement prediction of movement of an operation body,
wherein the control unit tracks a movement locus of the operation body that has entered a movement detection region identified by the image information, and performs the movement prediction on the basis of the movement locus.

2. The movement prediction device according to claim 1, wherein the control unit computes a position of a center of gravity of the operation body, and tracks a motion vector of the center of gravity as the movement locus of the operation body.

3. The movement prediction device according to claim 1, wherein the movement prediction device estimates a hand portion of the operation body whose image has been obtained in the movement detection region, and tracks a movement locus of the hand.

4. The movement prediction device according to claim 3, wherein the estimation of the hand is performed by detecting an outline of the operation body, obtaining sizes of portions of the outline and making a region including the portions with the sizes larger than or equal to a predetermined value be an effective region, and detecting a region circumscribing the outline in the effective region and determining whether or not a vertical length of the region circumscribing the outline is smaller than or equal to a threshold.

5. The movement prediction device according to claim 4, wherein when the vertical length of the circumscribing region is smaller than or equal to the threshold, a center of the effective region is defined as the center of gravity of the hand.

6. The movement prediction device according to claim 4, wherein when the vertical length of the circumscribing region is larger than the threshold, the determination regarding the effective region is performed again in a state in which the vertical length of the circumscribing region is limited and an estimated region of the hand is defined.

7. The movement prediction device according to claim 1, wherein the control unit tracks the movement locus of the operation body from a position through which the operation body entered the movement detection region.

8. The movement prediction device according to claim 1,
wherein the movement detection region is divided into a plurality of sections and
wherein the control unit performs the movement prediction on the basis of a fact that the movement locus of the operation body has entered a predetermined section among the plurality of sections.

9. An input apparatus comprising:
the movement prediction device according to claim 1; and
an operation panel for which an input operation is performed by the operation body,
wherein the movement prediction device and the operation panel are provided in a vehicle,
wherein the image pickup device is arranged in such a manner that at least an image of a region in front of the operation panel is obtained, and
wherein the control unit performs operation support for the operation panel on the basis of the movement prediction of the movement of the operation body.

10. The input apparatus according to claim 9, wherein the control unit is capable of identifying whether an operator for the operation panel is a driver or a passenger other than the driver on the basis of a position through which the operation body enters the movement detection region.
